(19) United States
(12) Patent Application Publication
(10) Pub. No.: US 2023/0093721 A1
(43) Pub. Date: Mar. 23, 2023

(54) HEAD-MOUNTED DISPLAY SYSTEM WITH COMPACT OPTICS

(71) Applicant: Valve Corporation, Bellevue, WA (US)

(72) Inventor: Joshua Mark Hudman, Issaquah, WA (US)

(21) Appl. No.: 17/483,024

(22) Filed: Sep. 23, 2021

(51) Int. Cl. H04N 13/332; G02F 1/1335; G02F 1/13363

(52) U.S. Cl. CPC H04N 13/332; G02F 1/133536; G02F 1/133541; G02F 1/133638

(57) ABSTRACT

A optical system of a head mounted display (HMD) system that includes a lens assembly comprising a first lens element and a second lens element that are directly or indirectly coupled together, for example, via a suitable optically clear adhesive. The lens assembly may include a quarter-wave plate disposed between the first and second lens elements. The first lens element may include a surface with an anti-reflective coating thereon, and the second lens element may include a surface with a partially reflective coating thereon. The optical system may include a reflective polarizer that, together with the lens assembly, focuses light from a display system to an eye of a user of the head mounted display system.

### BACKGROUND

### Technical Field

The present disclosure generally relates to optical systems, and more particularly, to optical systems for use with head mounted display systems.

### Description of the Related Art

Near-eye display technology may be used to present information and images to a user as part of a virtual reality (“VR”), augmented reality (“AR”), or mixed reality (“MR”) system. Such a near-eye display may be incorporated into a head-mounted display (“HMD”) device or headset. While these near-eye information displays can be oriented as direct-view, often the information displays are coupled with one or more lenses in the HMD. Lens systems may comprise lenses, various optical elements, aperture stops, and a lens housing to contain the various components in optical alignment with one another. Such lenses can enhance the VR or AR experience, but performance of lens systems depends, in part, on the design of each of the elements of the system as well as the overall design of the system, which sets forth the optical interaction among the elements.

### BRIEF SUMMARY

One general aspect includes a head-mounted display system operative to present images to an eye of a user. The head-mounted display system also includes a support structure configured to be worn on the head of the user. The system also includes a display system supported by the support structure. The system also includes an optical system supported by the support structure. The system also includes a first lens element that may include a first surface and a second surface opposite the first surface, the first surface of the first lens element facing the user's eye during operation and the second surface of the first lens element facing the display system. The system also includes a second lens element that may include a first surface and a second surface opposite the first surface, the first surface of the second lens element facing the display system and the second surface of the second lens element facing the user's eye, the first surface of the second lens element including a partial reflective coating. The system also includes a quarter-wave plate that may include a first surface and a second surface opposite the first surface, the first surface of the quarter-wave plate adhesively bonded (e.g., using a PSA) to the second surface of the first lens element, and the second surface of the quarter-wave plate adhesively bonded to the second surface of the second lens element. The system also includes a reflective polarizer positioned between the first surface of the first lens element and the user's eye. During operation, the reflective polarizer substantially transmits light having a first polarization state and substantially reflects light having a second polarization state orthogonal to the first polarization state.

Implementations may include one or more of the following features. The first surface of the first lens may include an anti-reflection coating. The reflective polarizer may include a reflective linear polarizer. Each of the first lens element and the second lens element may be a plano-convex lens element. The first surface of the first lens element may have a different surface profile than the first surface of the second lens element. The first lens element may be formed from a different material than the second lens element. The display system may produce circularly polarized light for the images. The first surface of the first lens element and the first surface of the second lens element may each have aspherical, spherical, or freeform surface profiles. The reflective polarizer may be adhesively bonded to an optically clear substrate. The quarter-wave plate may be oriented such that the quarter-wave plate converts incident circularly polarized light to linearly polarized light and converts incident linearly polarized light to circularly polarized light. The second surface of the first lens element and the second surface of the second lens element may be non-planar surfaces. The head-mounted display system may include: an optically-clear element that may include a first surface that is adhesively bonded to the display system and a second surface opposite the first surface that is adhesively bonded to the first surface of the second lens element. The reflective polarizer may be positioned on the first surface of the first lens element.

One general aspect includes a head-mounted display system operative to present images to a user. The head-mounted display system may also include a support structure configured to be worn on the head of the user. The system also includes first and second display systems supported by the support structure. The system also includes first and second optical systems supported by the support structure, each of the first and second optical systems positioned between a respective one of the first and second display systems. The system may also include a first lens element that may include a first surface and a second surface opposite the first surface. The system may also include a second lens element that may include a first surface and a second surface opposite the first surface, the first surface of the second lens element including a partial reflective coating, and the second surface of the first lens element is directly or indirectly adhesively bonded (e.g., PSA bonded) to the second surface of the second lens element. The system also includes a quarter-wave plate that may include a first surface and a second surface opposite the first surface. The system also includes a reflective polarizer positioned between the first surface of the first lens element and the user's eye during operation, the reflective polarizer substantially transmits light having a first polarization state and substantially reflects light having a second polarization state orthogonal to the first polarization state. Other embodiments of this aspect include corresponding computer systems, apparatus, and computer programs recorded on one or more computer storage devices, each configured to perform the actions of the methods.

Implementations may include one or more of the following features. The head-mounted display system where the second surface of the first lens element is directly adhesively bonded to the second surface of the second lens element. The first surface of the quarter-wave plate may be adhesively bonded to the second surface of the first lens element, and the second surface of the quarter-wave plate may be adhesively bonded to the second surface of the second lens element. The first surface of the first lens of each of the first and second optical systems may include an anti-reflection coating. The reflective polarizer may include a reflective linear polarizer. The reflective polarizer may be adhesively bonded to an optically clear substrate, and the quarter-wave plate is adhesively bonded to the reflective polarizer.

One general aspect includes an optical system configured to present images from a display system to an eye of a user. The optical system also includes a first lens element that may include a first surface and a second surface opposite the first surface, the first surface of the first lens element facing the user's eye during operation and the second surface of the first lens element facing the display system, the first surface of the first lens element including an anti-reflective coating. The system also includes a second lens element that may include a first surface and a second surface opposite the first surface, the first surface of the second lens element facing the display system and the second surface of the second lens element facing the user's eye, the first surface of the second lens element including a partial reflective coating. The system may also include a quarter-wave plate that may include a first surface and a second surface opposite the first surface, the first surface of the quarter-wave plate adhesively bonded to the second surface of the first lens element, and the second surface of the quarter-wave plate adhesively bonded to the second surface of the second lens element. The system may also include a reflective polarizer positioned between the first surface of the first lens element and the user's eye during operation, wherein the reflective polarizer substantially transmits light having a first polarization state and substantially reflects light having a second polarization state orthogonal to the first polarization state.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is an illustration of a head-mounted display system, according to one non-limiting illustrated implementation.

FIG. 2 is a schematic cross-section diagram of a portion of an example HMD system positioned relative to a user's eye, according to one non-limiting illustrated implementation.

FIG. 3 is a schematic cross-section diagram of a system that includes a display system and optical subsystem, wherein the optical system includes a quarter-wave plate bonded to first and second lens elements, according to one non-limiting illustrated implementation.

FIG. 4 is a schematic cross-section diagram of a system that includes a display system and optical subsystem, wherein the optical system includes first and second lens elements that are bonded together, according to one non-limiting illustrated implementation.

FIG. 5 is a schematic cross-section diagram of a system that includes a display system and optical subsystem, wherein the optical system includes first and second lens elements that are bonded together, and wherein the first and second lens elements include curved surfaces, according to one non-limiting illustrated implementation.

FIG. 6 is a schematic cross-section diagram of a system that includes a display system and optical subsystem, wherein the optical system includes a quarter-wave plate adhesively bonded to first and second lens elements, and further includes an optically clear component positioned between the display system and the optical system, according to one non-limiting illustrated implementation.

FIG. 7 is a schematic cross-section diagram of a system that includes a display and optical subsystem, wherein the optical system includes a quarter-wave plate adhesively bonded to first and second lens elements, and further includes a reflective polarizer positioned adjacent to one of the first and second lens elements, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

In various examples described herein, techniques and architectures may be used to produce an image focused onto an eye (one or both) of a user of a HMD device. Examples of a HMD device may include a display device worn on a user's head or as part of a helmet, such as a head-mounted display (“HMD”) device or headset, and may include position or motion sensors to measure inertial position or orientation of the HMD device. The display device may include a display in front of one eye, each eye, or both eyes. The display devices may include liquid crystal displays (LCDs), organic light-emitting diode (OLED), liquid crystal on silicon (LCoS), or cathode ray tubes (CRTs), just to name a few examples. A HMD device may display a computer-generated image, referred to as a virtual image. For example, a processor of the HMD device may render and display a synthetic (virtual) scene so that the viewer (wearer of the HMD device) perceives the scene as reality (or augmented reality), as described below.

In some examples, an LCD display device includes several components. Two of the components are the display matrix, which obstructs light in a granular or pixelated fashion to create an image, and a light source or backlight. The light source is typically positioned behind the display matrix and illuminates the image. For a color display, the backlight typically emits broad spectrum light, such as white light, for example.

Near-eye display technology may be used to present information and images to a user as part of a virtual reality (“VR”) or augmented reality (“AR”) system, which may be in the form of a HMD device, such as that introduced above. VR or AR HMDs may use one or more lenses to direct light associated with images displayed on one or more information displays (e.g., a pixelated LCD display device) to the user's eye(s). Among other things, lenses are used to bend light from the information display(s) so as to make the information display appear to the user to be farther away than it actually is. This provides the user a greater depth of field in the virtual environment and allows the user to more easily focus on the displayed image. Lenses also can be used in VR or AR headsets to increase the field of view of the information display for the user. A larger field of view can increase the immersive effect of the VR or AR system. Lenses can further be used in VR or AR headsets to shape the light from a single display so that the light received by the user is tailored separately for the user's left and right eyes. Use of separately tailored images for each eye can cause the user to perceive a stereoscopic or three-dimensional image, for example. Lenses are further designed in the near-eye environment with a constraint that the user's eyes are relatively close to the information display.

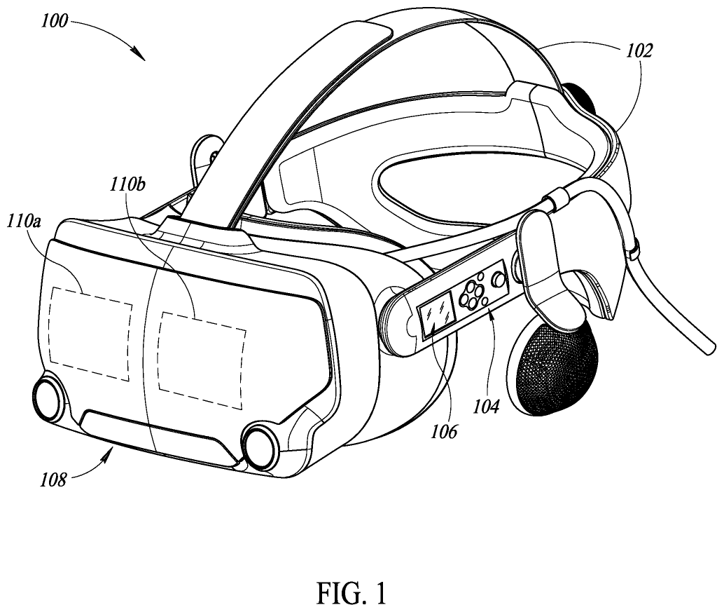

FIG. 1 is a schematic diagram depicting a wearable HMD device 100 that is wearable on the head of a user. A computing device associated with the HMD device 100 may provide rendering data associated with individual virtual content items to HMD device 100 and cause the individual virtual content items to be presented on a display associated with the HMD device 100, such as displays 110a and 110b shown in dashed lines in FIG. 1. Rendering data may include instructions for rendering a graphical representation of a virtual content item via a display of the device. For example, the rendering data may include instructions describing the geometry, viewpoint, texture, lighting, shading, etc. associated with a virtual content item. In an illustrative example, the virtual content items may be presented on the display of the HMD device 100 as part of a game that the user can play using the HMD device 100.

In some examples, the computing device may be located remotely from HMD device 100 in a network, such as the Internet. In other embodiments, the computing device may be collocated with the HMD device 100 (e.g., embedded in the HMD device 100, coupled to the HMD device via a wired or wireless connection). Moreover, HMD device 100 may be communicatively coupled to a network in any manner, such as by a global or local wired or wireless connection (e.g., local area network (LAN), intranet, Bluetooth, etc.). The network(s) may facilitate communication between the computing device(s) and the HMD device(s) 100 associated with one or more users.

In the illustrated embodiment, the HMD device 100 includes a set of straps 102 attached to a main body 108. The set of straps 102 are useable to selectively and securely mount the HMD device 100 to the head of the user for viewing visual content. The main body 108 may include a control panel 104 for controlling various aspects of the HMD device 100. Non-limiting examples of an electrical input device of the control panel 104 include a keypad having a set of keys for providing alphanumeric input or navigating a menu, or a dial or knob that is electrically coupled to the controller. The control panel 104 may include a display 106 for displaying information regarding the HMD device 100. In some embodiments, the display 106 may be a touchscreen input device that the user may interact with to control the HMD 100.

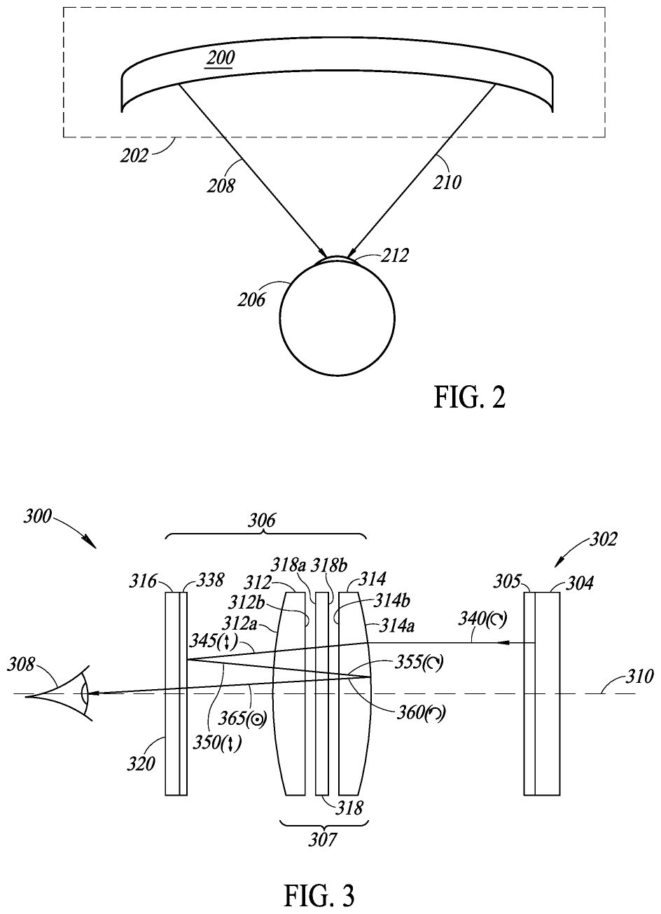

FIG. 2 is a schematic cross-section diagram of a portion 202 of a HMD device 200 positioned relative to a user's eye 206. For example, the HMD device 200 may be the same as or similar to the HMD device 100 of FIG. 1. In certain embodiments, HMD device 200 may be configured to display an image to be seen by both the left and right eyes of the user. This can be achieved using separate left and right LCD displays, or can be achieved using a single LCD display. Similarly, the HMD device 200 (e.g., in the form of a VR or AR headset) may include a single lens assembly or optical system or it may use individual left and right lens assemblies or optical systems.

Example light rays 208 and 210 illustrate possible paths of light from the HMD device 200 to the cornea 212 of the user's eye 206. The cornea 212 may be treated as having a substantially spherical shape. The HMD device 200 may include a near-to-eye display so that paths of light rays 208 and 210 are relatively short, such as to provide an eye relief of about 15 millimeters, for example. In this case, optics of the HMD device 200 are configured to focus light onto a surface (e.g., cornea 212) that is relatively close to the HMD device. Such a configuration may involve a pancake optical system that has a relatively thin profile that enables the pancake optical system to fit into HMD device 200 while allowing for a physical clearance from the user's eye 206.

FIG. 3 is a schematic cross-section diagram of a system 300 that includes a display and optical subsystem, according to one or more embodiments. The system 300 may be incorporated in a head-mountable device, such as the HMD devices 100 or 200, for example. However, it is to be appreciated that the system 300 may be incorporated in other types of devices including, without limitation, cameras, binoculars, office equipment, scientific instruments, etc. The system 300 may include a pixelated display device 302, sometimes called an information display or display system and an optical subsystem 306. A schematic representation of an eye 308 of a user is also illustrated. Such elements are aligned along an optical axis 310.

The display system 302 may include a pixelated display 304 and a circular polarizer 305 positioned in front of the pixelated display to provide circularly polarized light (right-handed in the non-limiting illustrative example). The display system 302 may include a backlight assembly, which emits light, may include a light source, such as one or more light emitting diodes (LEDs), one or more OLEDs, one or more cold cathode fluorescent lamps (CCFLs), one or more lasers, one or more quantum dots, or any combination of these example light sources. The light source in the backlight assembly may emit light across a broad spectrum (e.g., white light) so that the display system 302 can produce color images across the visible spectrum. The backlight assembly may emit light uniformly across its entire front face over a range of about 160 to 180 degrees, for example.

The display system 302, in coordination with the backlight assembly, may emit light over a range of angles up to about 180 degrees (light that is just shy of parallel to the face of the backlight assembly). This range of emission angles is sometimes referred to as the backlight assembly's field of view or the backlight assembly's cone of light. In some embodiments, the display 304 of the display system 302 may be an LCD matrix that includes one or more polarizing layers, a liquid crystal layer, and a thin film transistor layer. The LCD matrix creates images by obscuring portions of the backlight in a pixelated fashion. An image is displayed when light is emitted from backlight assembly and passes through the display 304 (e.g., an LCD matrix) and through the circular polarizer 305. The backlight assembly and the display may be separated from each other, or these two components may be sandwiched together with little, if any, space between them.

The optical subsystem 306 may include a lens assembly 307 to direct light from the display 302 toward the user's eye 308. The optical subsystem 306 may have a pancake configuration, for example. In this case, the optical subsystem 306 may include an assembly of optical elements configured to direct light from the display system 302 toward the user's eye 308 using on-axis optical folding based, at least in part, on polarization of the light, as described further below. In some embodiments, the lens assembly 307 of the optical system 306 includes a first lens element 312, a second lens element 314, and a quarter-wave plate 318 positioned between the first and second lens elements. Although shown spaced apart for explanatory purposes, the first and second lens elements 312 and 314 may be affixed to (e.g., adhesively bonded using an optically clear adhesive, such as a pressure-sensitive adhesive or PSA) the quarter-wave plate 318.

In the illustrated implementation, the first lens element 312 includes a first surface 312a and a second surface 312b opposite the first surface, wherein the first surface 312a faces the user's eye 308 during operation and the second surface 312b faces the display system 302. The second lens element 314 includes a first surface 314a and a second surface 314b opposite the first surface, wherein first surface 314a of the second lens element 314 faces the display system 302 and the second surface 314b of the second lens element 314 faces the user's eye 308. The first surface 314a of the second lens element 314 may include a partially reflective coating, such as a coating that reflects 50 percent of incident light and transmits 50 percent of incident light. The partially reflective coating may be polarization independent or polarization dependent. The quarter-wave plate 318 includes a first surface 318a and a second surface 318b opposite the first surface. The first surface 318a of the quarter-wave plate 318 may be adhesively bonded to the second surface 312b of the first lens element 312, and the second surface 318b of the quarter-wave plate 318 may be adhesively bonded to the second surface 314b of the second lens element 314 to form the lens assembly 307. In at least some implementations, the first surface 312a of the first lens element 312 and/or the first surface 314a of the second lens element 314 have aspherical, spherical, or freeform surface profiles.

The optical subsystem 306 may include various other optical elements. For example, optical subsystem 306 may include at least one polarizing beam splitter 338, also referred to herein as a reflective polarizer. In at least some implementations, the reflective polarizer 338 may be adhesively bonded to an optically clear substrate 316 (e.g., via a suitable optically clear adhesive, such as PSA). The reflective polarizer 338 may be located between the first lens element 312 and an exit surface (or side) 320 of the optical subsystem 306. The reflective polarizer 338 may substantially transmit light having a first polarization state and substantially reflects light having a second polarization state orthogonal to the first polarization state. In at least some implementations, the reflective polarizer 338 may represent a beam splitter that only lets linearly polarized light of a first orientation (e.g., horizontal) pass through it, thereby reflecting all other light that is not linearly polarized in the first orientation. The reflective polarizer 338 may be considered a linear polarizer reflector, or a reflective linear polarizer. That is, the reflective polarizer 338 may combine the functionality of a linear polarizer and a beam splitter into a single element in at least some implementations.

FIG. 3 shows a folded optical path of the optical system 306, in accordance with one or more embodiments. One or more surfaces of the first lens element 312 or the second lens element 314 may have various shapes, such as spherically concave (e.g., a portion of a sphere), spherically convex, planar, aspheric, a freeform shape, or some other shape. In some embodiments, the shape of one or more surfaces of the first lens element 312 or the second lens element 314 can be designed to additionally correct for various forms of optical aberration. In at least some implementations, the first surfaces 312a and 314b of the first and second lens elements 312 and 314, respectively, may be convex surfaces, and the second surfaces 312b and 314b of the first and second lens elements 312 and 314, respectively, may be planar surfaces. In some embodiments, one or more of the optical elements within the lens assembly 307 may have one or more coatings or layers, such as anti-reflective coatings and enhance contrast coatings, as discussed above. For example, the first surface 312a of the first lens element 312 may include an anti-reflective coating, and the first surface 314a of the second lens element 314 may include a partially reflective coating, as discussed above.

As noted above, the display system 302 includes a circular polarizer 305 that converts light emitted from the display 304 into circular polarized light. In one or more embodiments, the circular polarizer 305 is a film on the surface of the display 304. The first surface 314a of the second lens element 314 includes the partial reflector coating (e.g., a 50/50 mirror) that is configured to reflect a portion of light incident on its surface and transmit another portion. The quarter-wave plate 318 is configured to convert circularly polarized light into linearly polarized light and vice versa. The first surface 312a of the first lens element 312 includes an anti-reflective coating, and the reflective polarizer 338 is configured to transmit a desired polarization state while reflecting other polarization states.

In operation, light 340 is directed from the display 304 and the circular polarizer 305 to the partial reflector on the surface 314a of the second lens element 314. The light 340 exiting the circular polarizer 305 is right-handed circularly polarized in this example. A first portion (not shown) of the light 340 is reflected by the partial reflector on the surface 314a of the second lens element 314, and a second portion of the light 340 is transmitted by the partial reflector through the second lens element 314 towards quarter-wave plate 318. In some embodiments, the partial reflector on the surface 314a is configured to reflect 50% of incident light (e.g., light 340). The quarter-wave plate 318 changes the polarization of light 340 from circular to linear (referred to as light 345). Light 345 is incident on the reflective polarizer 338, which reflects light that is polarized in a blocking direction (e.g., vertical or “y-direction”) and transmits light that is polarized in a perpendicular direction to the blocking direction (e.g., horizontal or “x-direction”). At this point, light 345 is linearly polarized in the blocking direction. Thus, the reflective polarizer 338 reflects light 345 and the reflected light is referred to as light 350. Light 350 is incident on the quarter-wave plate 318 after passing through the first lens element 312, which changes the light 350 from being linear polarized to light 355 that is circularly polarized. The partial reflector at the first surface 314a of the second lens element 314 reflects a portion of the light 355 (while transmitting another portion), as described above. The reflected portion of light 355 is reflected back toward the quarter-wave plate 318 as light 360, which is also circularly polarized. However, the handedness of the light 360 is opposite that of light 355 and 340 due to the reflection from the partial reflector on the surface 314a. In the illustrated example, the light 340 and 355 is right-handed circularly polarized, whereas the light 360 is left-handed circularly polarized. Thus, the quarter-wave plate 318 changes the polarization of the light 360 from circularly polarized to light 365 that is linearly polarized. However, as the handedness of the light 360 is opposite to that of light 355, the polarization of the light 365 is perpendicular to that of light 355. Accordingly, the light 365 is linearly polarized in a direction (e.g., horizontal or “x-direction”) perpendicular to the blocking direction (e.g., vertical or “y-direction”) and is therefore transmitted by the reflective polarizer 338 as light 365 to the eye 308 of the user.

Although the example describes that the reflective polarizer 338 allows horizontally polarized light to pass through to the user's eye 308, and otherwise reflects all other light that is not horizontally polarized light, it is to be appreciated that the reflective polarizer 338 may allow vertically polarized light to pass through to the user's eye 308, and otherwise reflect all other light that is not vertically polarized.

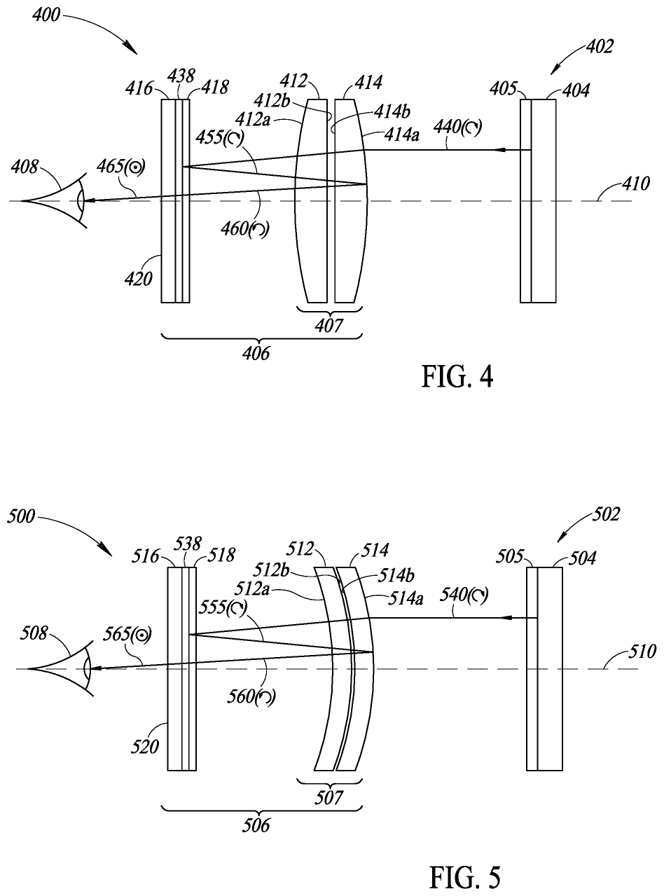

FIG. 4 is a schematic cross-section diagram of a system 400 that includes a display and optical subsystem, according to one or more embodiments. The system 400 may be incorporated in a head-mountable device, such as the HMD devices 100 or 200, for example. However, it is to be appreciated that the system 400 may be incorporated in other types of devices including, without limitation, cameras, binoculars, office equipment, scientific instruments, etc. Many of the components or features of the system 400 may be similar or identical to components of other systems described herein. Accordingly, the description of such other systems may also apply to the system 400. Further, one or more features or components of the system 400 may be combined with one or more features or components of other systems described herein, and vice versa, such that any combination of the systems of the present disclosure may be used to implement the techniques described herein.

The system 400 may include a pixelated display device or system 402, sometimes called an information display or display system, and an optical subsystem 406. A schematic representation of an eye 408 of a user is also illustrated. Such elements are aligned along an optical axis 410.

The display system 402 may include a pixelated display 404 and a circular polarizer 405 positioned in front of the pixelated display to provide circularly polarized light (right-handed in the non-limiting illustrative example). The display system 402 may include a backlight assembly, which emits light, may include a light source, such as one or more light emitting diodes (LEDs), one or more OLEDs, one or more cold cathode fluorescent lamps (CCFLs), one or more lasers, one or more quantum dots, or any combination of these example light sources. The light source in the backlight assembly may emit light across a broad spectrum (e.g., white light) so that the display system 402 can produce color images across the visible spectrum. The backlight assembly may emit light uniformly across its entire front face over a range of about 160 to 180 degrees, for example.

The display system 402, in coordination with the backlight assembly, may emit light over a range of angles up to about 180 degrees (light that is just shy of parallel to the face of the backlight assembly). This range of emission angles is sometimes referred to as the backlight assembly's field of view or the backlight assembly's cone of light. In some embodiments, the display 404 of the display system 402 may be an LCD matrix that includes one or more polarizing layers, a liquid crystal layer, and a thin film transistor layer. The LCD matrix creates images by obscuring portions of the backlight in a pixelated fashion. An image is displayed when light is emitted from backlight assembly and passes through the display 404 (e.g., an LCD matrix) and through the circular polarizer 405. The backlight assembly and the display may be separated from each other, or these two components may be sandwiched together with little, if any, space between them.

The optical subsystem 406 may include a lens assembly 407 to direct light from the display system 402 toward the user's eye 408. The optical subsystem 406 may have a pancake configuration, for example. In this case, the optical subsystem 406 may include an assembly of optical elements configured to direct light from the display system 402 toward the user's eye 408 using on-axis optical folding based, at least in part, on polarization of the light, as described further below. In some embodiments, the lens assembly 407 of the optical system 406 includes a first lens element 412 and a second lens element 414. Although shown spaced apart for explanatory purposes, the first and second lens elements 412 and 414 may be affixed to each other (e.g., adhesively bonded using an optically clear adhesive).

In the illustrated implementation, the first lens element 412 includes a first surface 412a and a second surface 412b opposite the first surface, wherein the first surface 412a faces the user's eye 408 during operation and the second surface 412b faces the display system 402. The second lens element 414 includes a first surface 414a and a second surface 414b opposite the first surface, wherein first surface 414a of the second lens element 414 faces the display system 402 and the second surface 414b of the second lens element 414 faces the user's eye 408. The first surface 414a of the second lens element 414 may include a partially reflective coating, such as a coating that reflects 50 percent of incident light and transmits 50 percent of incident light. The partially reflective coating may be polarization independent or polarization dependent. The second surface 412b of the first lens element 412 may be adhesively bonded to the second surface 414b of the second lens element 414 to form the lens assembly 407.

The optical subsystem 406 may include various other optical elements. For example, optical subsystem 406 may include at least one reflective polarizer 438 and a quarter-wave plate 418. In at least some implementations, the reflective polarizer 438 may be adhesively bonded to an optically clear substrate 416 (e.g., via a suitable optically clear adhesive), and the quarter-wave plate 418 may be bonded to the reflective polarizer. The reflective polarizer 438 may be located between the first lens element 412 and an exit surface (or side) 420 of the optical subsystem 406. The reflective polarizer 438 may substantially transmit light having a first polarization state and substantially reflects light having a second polarization state orthogonal to the first polarization state. In at least some implementations, the reflective polarizer 438 may represent a beam splitter that only lets linearly polarized light of a first orientation (e.g., horizontal) pass through it, thereby reflecting all other light that is not linearly polarized in the first orientation. The reflective polarizer 438 may be considered a linear polarizer reflector, or a reflective linear polarizer. That is, the reflective polarizer 438 may combine the functionality of a linear polarizer and a beam splitter into a single element in at least some implementations.

FIG. 4 shows a folded optical path of the optical system 406, in accordance with one or more embodiments. One or more surfaces of the first lens element 412 or the second lens element 414 may have various shapes, such as spherically concave (e.g., a portion of a sphere), spherically convex, planar, aspheric, a freeform shape, or some other shape. In some embodiments, the shape of one or more surfaces of the first lens element 412 or the second lens element 414 can be designed to additionally correct for various forms of optical aberration. In at least some implementations, the first surfaces 412a and 414b of the first and second lens elements 412 and 414, respectively, may be convex surfaces, and the second surfaces 412b and 414b of the first and second lens elements 412 and 414, respectively, may be planar surfaces. In some embodiments, one or more of the optical elements within the lens assembly 407 may have one or more coatings or layers, such as anti-reflective coatings and enhance contrast coatings, as discussed above. For example, the first surface 412a of the first lens element 412 may include an anti-reflective coating, and the first surface 414a of the second lens element 414 may include a partially reflective coating, as discussed above.

As noted above, the display system 402 includes a circular polarizer 405 that converts light emitted from the display 404 into circular polarized light. In one or more embodiments, the circular polarizer 405 is a film on the surface of the display 404. The first surface 414a of the second lens element 414 includes the partial reflector coating (e.g., a 50/50 mirror) that is configured to reflect a portion of light incident on its surface and transmit another portion. The quarter-wave plate 418 is configured to convert circularly polarized light into linearly polarized light and vice versa. The first surface 412a of the first lens element 412 includes an anti-reflective coating, and the reflective polarizer 438 is configured to transmit a desired polarization state while reflecting other polarization states. In operation, light 440 is directed from the display 404 and the circular polarizer 405 to the partial reflector on the surface 414a of the second lens element 414. The light 440 exiting the circular polarizer 405 is right-handed circularly polarized in this example. A first portion (not shown) of the light 440 is reflected by the partial reflector on the surface 414a of the second lens element 414, and a second portion of the light 440 is transmitted by the partial reflector through the second lens element 414 and the first lens element 412 towards quarter-wave plate 418. In some embodiments, the partial reflector on the surface 414a is configured to reflect 50% of incident light (e.g., light 440). The quarter-wave plate 418 changes the polarization of light 440 from circularly polarized to linearly polarized. The light is incident on the reflective polarizer 438 from the quarter-wave plate 418, which reflects light that is polarized in a blocking direction (e.g., vertical or “y-direction”) and transmits light that is polarized in a perpendicular direction to the blocking direction (e.g., horizontal or “x-direction”). At this point, light incident on the reflective polarizer 438 is linearly polarized in the blocking direction. Thus, the reflective polarizer 438 reflects the light back through the quarter-wave plate 418, which changes the light from being linear polarized to light 455 that is circularly polarized. The light 455 passes back through the first and second lens elements 412 and 414. The partial reflector at the surface 414a of the second lens element 414 reflects a portion of the light 455 (while transmitting another portion), as described above. The reflected portion of light 455 is reflected back through the second lens element 414 and the first lens element 412 toward the quarter-wave plate 418 as light 460, which is also circularly polarized. However, the handedness of the light 460 is opposite that of light 455 and 440 due to the reflection from the partial reflector on the surface 414a. In the illustrated example, the light 440 and 455 is right-handed circularly polarized, whereas the light 460 is left-handed circularly polarized. Thus, the quarter-wave plate 418 changes the polarization of the light 460 from circularly polarized to light 465 that is linearly polarized. However, as the handedness of the light 460 is opposite to that of light 455, the polarization of the light 465 is perpendicular to that of light 455. Accordingly, the light 465 is linearly polarized in a direction (e.g., horizontal or “x-direction”) perpendicular to the blocking direction (e.g., vertical or “y-direction”) and is therefore transmitted by the reflective polarizer 438 as light 465 to the eye 408 of the user.

Although the example describes that the reflective polarizer 438 allows horizontally polarized light to pass through to the user's eye 408, and otherwise reflects all other light that is not horizontally polarized light, it is to be appreciated that the reflective polarizer 438 may allow vertically polarized light to pass through to the user's eye 408, and otherwise reflect all other light that is not vertically polarized.

FIG. 5 is a schematic cross-section diagram of a system 500 that includes a display and optical subsystem, according to one or more embodiments. The system 500 may be incorporated in a head-mountable device, such as the HMD devices 100 or 200, for example. However, it is to be appreciated that the system 500 may be incorporated in other types of devices including, without limitation, cameras, binoculars, office equipment, scientific instruments, etc. Many of the components or features of the system 500 may be similar or identical to components of other systems described herein. Accordingly, the description of such other systems may also apply to the system 500. Further, one or more features or components of the system 500 may be combined with one or more features or components of other systems described herein, and vice versa, such that any combination of the systems of the present disclosure may be used to implement the techniques described herein.

The system 500 may include a pixelated display device or system 502, sometimes called an information display or display system, and an optical subsystem 506. A schematic representation of an eye 508 of a user is also illustrated. Such elements are aligned along an optical axis 510.

The display system 502 may include a pixelated display 504 and a circular polarizer 505 positioned in front of the pixelated display to provide circularly polarized light (right-handed in the non-limiting illustrative example). The display system 502 may include a backlight assembly, which emits light, may include a light source, such as one or more light emitting diodes (LEDs), one or more OLEDs, one or more cold cathode fluorescent lamps (CCFLs), one or more lasers, one or more quantum dots, or any combination of these example light sources. The light source in the backlight assembly may emit light across a broad spectrum (e.g., white light) so that the display system 502 can produce color images across the visible spectrum. The backlight assembly may emit light uniformly across its entire front face over a range of about 160 to 180 degrees, for example.

The display system 502, in coordination with the backlight assembly, may emit light over a range of angles up to about 180 degrees (light that is just shy of parallel to the face of the backlight assembly). This range of emission angles is sometimes referred to as the backlight assembly's field of view or the backlight assembly's cone of light. In some embodiments, the display 504 of the display system 502 may be an LCD matrix that includes one or more polarizing layers, a liquid crystal layer, and a thin film transistor layer. The LCD matrix creates images by obscuring portions of the backlight in a pixelated fashion. An image is displayed when light is emitted from backlight assembly and passes through the display 504 (e.g., an LCD matrix) and through the circular polarizer 505. The backlight assembly and the display may be separated from each other, or these two components may be sandwiched together with little, if any, space between them.

The optical subsystem 506 may include a lens assembly 507 to direct light from the display system 502 toward the user's eye 508. The optical subsystem 506 may have a pancake configuration, for example. In this case, the optical subsystem 506 may include an assembly of optical elements configured to direct light from the display system 502 toward the user's eye 508 using on-axis optical folding based, at least in part, on polarization of the light, as described further below. In some embodiments, the lens assembly 507 of the optical system 506 includes a first lens element 512 and a second lens element 514. Although shown spaced apart for explanatory purposes, the first and second lens elements 512 and 514 may be affixed to each other (e.g., adhesively bonded using an optically clear adhesive).

In the illustrated implementation, the first lens element 512 includes a first surface 512a and a second surface 512b opposite the first surface, wherein the first surface 512a faces the user's eye 508 during operation and the second surface 512b faces the display system 502. The second lens element 514 includes a first surface 514a and a second surface 514b opposite the first surface, wherein first surface 514a of the second lens element 514 faces the display system 502 and the second surface 514b of the second lens element 514 faces the user's eye 508. The first surface 514a of the second lens element 514 may include a partially reflective coating, such as a coating that reflects 50 percent of incident light and transmits 50 percent of incident light. The partially reflective coating may be polarization independent or polarization dependent. The second surface 512b of the first lens element 512 may be adhesively bonded to the second surface 514b of the second lens element 514 to form the lens assembly 507.

The optical subsystem 506 may include various other optical elements. For example, optical subsystem 506 may include at least one reflective polarizer 538 and a quarter-wave plate 518. In at least some implementations, the reflective polarizer 538 may be adhesively bonded to an optically clear substrate 516 (e.g., via a suitable optically clear adhesive), and the quarter-wave plate 518 may be bonded to the reflective polarizer. The reflective polarizer 538 may be located between the first lens element 512 and an exit surface (or side) 520 of the optical subsystem 506. The reflective polarizer 538 may substantially transmit light having a first polarization state and substantially reflects light having a second polarization state orthogonal to the first polarization state. In at least some implementations, the reflective polarizer 538 may represent a beam splitter that only lets linearly polarized light of a first orientation (e.g., horizontal) pass through it, thereby reflecting all other light that is not linearly polarized in the first orientation. The reflective polarizer 538 may be considered a linear polarizer reflector, or a reflective linear polarizer. That is, the reflective polarizer 538 may combine the functionality of a linear polarizer and a beam splitter into a single element in at least some implementations.

FIG. 5 shows a folded optical path of the optical system 506, in accordance with one or more embodiments. One or more surfaces of the first lens element 512 or the second lens element 514 may have various shapes, such as spherically concave (e.g., a portion of a sphere), spherically convex, planar, aspheric, a freeform shape, or some other shape. In some embodiments, the shape of one or more surfaces of the first lens element 512 or the second lens element 514 can be designed to additionally correct for various forms of optical aberration. In at least some implementations, the first surface 512a of the first lens element 512 and the second surface 514b of the second lens element 514 are curved (e.g., concave) surfaces, and the second surface 514b of the first lens element and the first surface of the second lens element are curved (e.g., convex) surfaces. In some embodiments, one or more of the optical elements within the lens assembly 507 may have one or more coatings or layers, such as anti-reflective coatings and enhance contrast coatings, as discussed above. For example, the first surface 512a of the first lens element 512 may include an anti-reflective coating, and the first surface 514a of the second lens element 514 may include a partially reflective coating, as discussed above.

As noted above, the display system 502 includes a circular polarizer 505 that converts light emitted from the display 504 into circular polarized light. In one or more embodiments, the circular polarizer 505 is a film on the surface of the display 504. The first surface 514a of the second lens element 514 includes the partial reflector coating (e.g., a 50/50 mirror) that is configured to reflect a portion of light incident on its surface and transmit another portion. The quarter-wave plate 518 is configured to convert circularly polarized light into linearly polarized light and vice versa. The first surface 512a of the first lens element 512 includes an anti-reflective coating, and the reflective polarizer 538 is configured to transmit a desired polarization state while reflecting other polarization states.

In operation, light 540 is directed from the display 504 and the circular polarizer 505 to the partial reflector on the surface 514a of the second lens element 514. The light 540 exiting the circular polarizer 505 is right-handed circularly polarized in this example. A first portion (not shown) of the light 540 is reflected by the partial reflector on the surface 514a of the second lens element 514, and a second portion of the light 540 is transmitted by the partial reflector through the second lens element 514 and the first lens element 512 towards quarter-wave plate 518. In some embodiments, the partial reflector on the surface 514a is configured to reflect 50% of incident light (e.g., light 540). The quarter-wave plate 518 changes the polarization of light 540 from circularly polarized to linearly polarized. The light is incident on the reflective polarizer 538 from the quarter-wave plate 518, which reflects light that is polarized in a blocking direction (e.g., vertical or “y-direction”) and transmits light that is polarized in a perpendicular direction to the blocking direction (e.g., horizontal or “x-direction”). At this point, light incident on the reflective polarizer 538 is linearly polarized in the blocking direction. Thus, the reflective polarizer 538 reflects the light back through the quarter-wave plate 518, which changes the light from being linear polarized to light 555 that is circularly polarized. The light 555 passes back through the first and second lens elements 512 and 514. The partial reflector at the surface 514a of the second lens element 514 reflects a portion of the light 555 (while transmitting another portion), as described above. The reflected portion of light 555 is reflected back through the second lens element 514 and the first lens element 512 toward the quarter-wave plate 518 as light 560, which is also circularly polarized. However, the handedness of the light 560 is opposite that of light 555 and 540 due to the reflection from the partial reflector on the surface 514a. In the illustrated example, the light 540 and 555 is right-handed circularly polarized, whereas the light 560 is left-handed circularly polarized. Thus, the quarter-wave plate 518 changes the polarization of the light 560 from circularly polarized to light 565 that is linearly polarized. However, as the handedness of the light 560 is opposite to that of light 555, the polarization of the light 565 is perpendicular to that of light 555. Accordingly, the light 565 is linearly polarized in a direction (e.g., horizontal or “x-direction”) perpendicular to the blocking direction (e.g., vertical or “y-direction”) and is therefore transmitted by the reflective polarizer 538 as light 565 to the eye 508 of the user.

Although the example describes that the reflective polarizer 538 allows horizontally polarized light to pass through to the user's eye 508, and otherwise reflects all other light that is not horizontally polarized light, it is to be appreciated that the reflective polarizer 538 may allow vertically polarized light to pass through to the user's eye 508, and otherwise reflect all other light that is not vertically polarized.

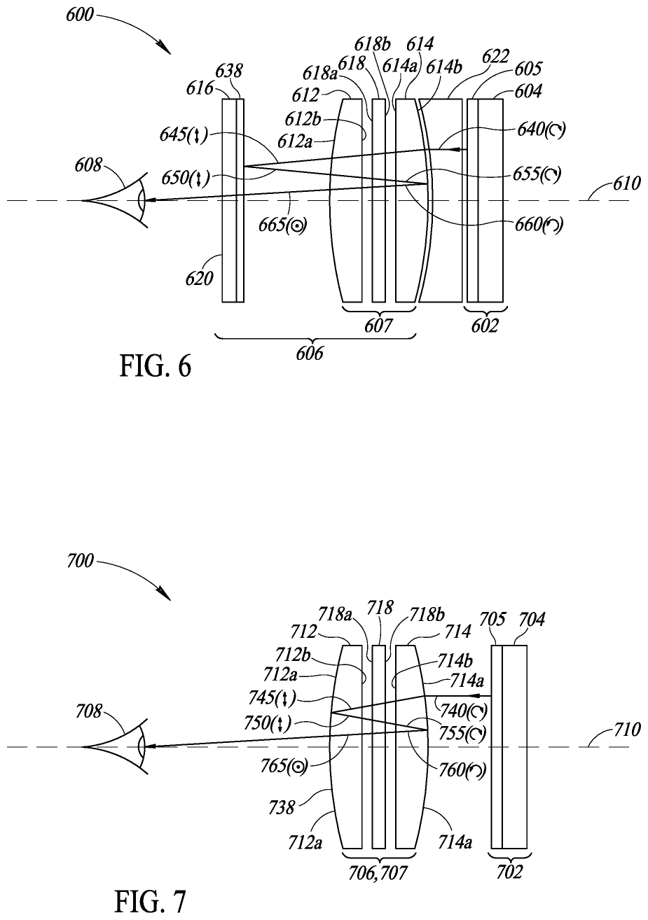

FIG. 6 is a schematic cross-section diagram of a system 600 that includes a display and optical subsystem, according to one or more embodiments. The system 600 may be incorporated in a head-mountable device, such as the HMD devices 100 or 200, for example. However, it is to be appreciated that the system 600 may be incorporated in other types of devices including, without limitation, cameras, binoculars, office equipment, scientific instruments, etc. Many of the components or features of the system 600 may be similar or identical to components of other systems described herein. Accordingly, the description of such other systems may also apply to the system 600. Further, one or more features or components of the system 600 may be combined with one or more features or components of other systems described herein, and vice versa, such that any combination of the systems of the present disclosure may be used to implement the techniques described herein.

The system 600 may include a display system 602, an optical subsystem 606, and an optically clear component 622 (e.g., plastic) positioned between the display system and the optical system. A schematic representation of an eye 608 of a user is also illustrated. Such elements are aligned along an optical axis 610. The display system 602 may include a pixelated display 604 and a circular polarizer 605 positioned in front of the pixelated display to provide circularly polarized light (right-handed in the non-limiting illustrative example). The display system 602 may include a backlight assembly, which emits light, may include a light source, such as one or more light emitting diodes (LEDs), one or more OLEDs, one or more cold cathode fluorescent lamps (CCFLs), one or more lasers, one or more quantum dots, or any combination of these example light sources. The light source in the backlight assembly may emit light across a broad spectrum (e.g., white light) so that the display system 602 can produce color images across the visible spectrum. The backlight assembly may emit light uniformly across its entire front face over a range of about 160 to 180 degrees, for example.

The display system 602, in coordination with the backlight assembly, may emit light over a range of angles up to about 180 degrees (light that is just shy of parallel to the face of the backlight assembly). This range of emission angles is sometimes referred to as the backlight assembly's field of view or the backlight assembly's cone of light. In some embodiments, the display 604 of the display system 602 may be an LCD matrix that includes one or more polarizing layers, a liquid crystal layer, and a thin film transistor layer. The LCD matrix creates images by obscuring portions of the backlight in a pixelated fashion. An image is displayed when light is emitted from backlight assembly and passes through the display 604 (e.g., an LCD matrix) and through the circular polarizer 605. The backlight assembly and the display may be separated from each other, or these two components may be sandwiched together with little, if any, space between them.

The optical subsystem 606 may include a lens assembly 607 to direct light from the display 602 toward the user's eye 608. The optical subsystem 606 may have a pancake configuration, for example. In this case, the optical subsystem 606 may include an assembly of optical elements configured to direct light from the display system 602 toward the user's eye 608 using on-axis optical folding based, at least in part, on polarization of the light, as described further below. In some embodiments, the lens assembly 607 of the optical system 606 includes a first lens element 612, a second lens element 614, and a quarter-wave plate 618 positioned between the first and second lens elements. Although shown spaced apart for explanatory purposes, the first and second lens elements 612 and 614 may be affixed to (e.g., adhesively bonded using an optically clear adhesive) the quarter-wave plate 618.

In the illustrated implementation, the first lens element 612 includes a first surface 612a and a second surface 612b opposite the first surface, wherein the first surface 612a faces the user's eye 608 during operation and the second surface 612b faces the display system 602. The second lens element 614 includes a first surface 614a and a second surface 614b opposite the first surface, wherein first surface 614a of the second lens element 614 faces the display system 602 and the second surface 614b of the second lens element 614 faces the user's eye 608. The first surface 614a of the second lens element 614 may include a partially reflective coating, such as a coating that reflects 50 percent of incident light and transmits 50 percent of incident light. The partially reflective coating may be polarization independent or polarization dependent. The quarter-wave plate 618 includes a first surface 618a and a second surface 618b opposite the first surface. The first surface 618a of the quarter-wave plate 618 may be adhesively bonded to the second surface 612b of the first lens element 612, and the second surface 618b of the quarter-wave plate 618 may be adhesively bonded to the second surface 614b of the second lens element 614 to form the lens assembly 607.

In the illustrated embodiment, the optically clear component 622 may be disposed between the first surface 614a of the second lens element 614 and the circular polarizer 605 of the display system 602. As a non-limiting example, the optically clear component 622 may be adjacent both the first surface 614a of the second lens element 614 and the circular polarizer 605 of the display system 602. In at least some implementations, the optically clear component 622 may be adhesively bonded to both the first surface 614a of the second lens element 614 and the circular polarizer 605 of the display system 602.

The optical subsystem 606 may include various other optical elements. For example, the optical subsystem 606 may include at least one polarizing beam splitter 638, also referred to herein as a reflective polarizer. In at least some implementations, the reflective polarizer 638 may be adhesively bonded to an optically clear substrate 616 (e.g., via a suitable optically clear adhesive). The reflective polarizer 638 may be located between the first lens element 612 and an exit surface (or side) 620 of the optical subsystem 606. The reflective polarizer 638 may substantially transmit light having a first polarization state and substantially reflects light having a second polarization state orthogonal to the first polarization state. In at least some implementations, the reflective polarizer 638 may represent a beam splitter that only lets linearly polarized light of a first orientation (e.g., horizontal) pass through it, thereby reflecting all other light that is not linearly polarized in the first orientation. The reflective polarizer 638 may be considered a linear polarizer reflector, or a reflective linear polarizer. That is, the reflective polarizer 638 may combine the functionality of a linear polarizer and a beam splitter into a single element in at least some implementations.

FIG. 6 shows a folded optical path of the optical system 606, in accordance with one or more embodiments. One or more surfaces of the first lens element 612 or the second lens element 614 may have various shapes, such as spherically concave (e.g., a portion of a sphere), spherically convex, planar, aspheric, a freeform shape, or some other shape. In some embodiments, the shape of one or more surfaces of the first lens element 612 or the second lens element 614 can be designed to additionally correct for various forms of optical aberration. In at least some implementations, the first surfaces 612a and 614b of the first and second lens elements 612 and 614, respectively, may be convex surfaces, and the second surfaces 612b and 614b of the first and second lens elements 612 and 614, respectively, may be planar surfaces. In some embodiments, one or more of the optical elements within the lens assembly 607 may have one or more coatings or layers, such as anti-reflective coatings and enhance contrast coatings, as discussed above. For example, the first surface 612a of the first lens element 612 may include an anti-reflective coating, and the first surface 614a of the second lens element 614 may include a partially reflective coating, as discussed above.

As noted above, the display system 602 includes a circular polarizer 605 that converts light emitted from the display 604 into circular polarized light. In one or more embodiments, the circular polarizer 605 is a film on the surface of the display 604. The first surface 614a of the second lens element 614 includes the partial reflector coating (e.g., a 50/50 mirror) that is configured to reflect a portion of light incident on its surface and transmit another portion. The quarter-wave plate 618 is configured to convert circularly polarized light into linearly polarized light and vice versa. The first surface 612a of the first lens element 612 includes an anti-reflective coating, and the reflective polarizer 638 is configured to transmit a desired polarization state while reflecting other polarization states.

In operation, light 640 is directed from the display 604 and the circular polarizer 605 to the partial reflector on the surface 614a of the second lens element 614. The light 640 exiting the circular polarizer 605 is right-handed circularly polarized in this example. A first portion (not shown) of the light 640 is reflected by the partial reflector on the surface 614a of the second lens element 614, and a second portion of the light 640 is transmitted by the partial reflector through the second lens element 614 towards quarter-wave plate 618. In some embodiments, the partial reflector on the surface 614a is configured to reflect 50% of incident light (e.g., light 640). The quarter-wave plate 618 changes the polarization of light 640 from circular to linear (referred to as light 645). Light 645 is incident on the reflective polarizer 638, which reflects light that is polarized in a blocking direction (e.g., vertical or “y-direction”) and transmits light that is polarized in a perpendicular direction to the blocking direction (e.g., horizontal or “x-direction”). At this point, light 645 is linearly polarized in the blocking direction. Thus, the reflective polarizer 638 reflects light 645 and the reflected light is referred to as light 650. Light 650 is incident on the quarter-wave plate 618 after passing through the first lens element 612, which changes the light 650 from being linear polarized to light 655 that is circularly polarized. The partial reflector at the surface 614a of the second lens element 614 reflects a portion of the light 655 (while transmitting another portion), as described above. The reflected portion of light 655 is reflected back toward the quarter-wave plate 618 as light 660, which is also circularly polarized. However, the handedness of the light 660 is opposite that of light 655 and 640 due to the reflection from the partial reflector on the surface 614a. In the illustrated example, the light 640 and 655 is right-handed circularly polarized, whereas the light 660 is left-handed circularly polarized. Thus, the quarter-wave plate 618 changes the polarization of the light 660 from circularly polarized to light 665 that is linearly polarized. However, as the handedness of the light 660 is opposite to that of light 655, the polarization of the light 665 is perpendicular to that of light 655. Accordingly, the light 665 is linearly polarized in a direction (e.g., horizontal or “x-direction”) perpendicular to the blocking direction (e.g., vertical or “y-direction”) and is therefore transmitted by the reflective polarizer 638 as light 665 to the eye 608 of the user.

Although the example describes that the reflective polarizer 638 allows horizontally polarized light to pass through to the user's eye 608, and otherwise reflects all other light that is not horizontally polarized light, it is to be appreciated that the reflective polarizer 638 may allow vertically polarized light to pass through to the user's eye 608, and otherwise reflect all other light that is not vertically polarized.

FIG. 7 is a schematic cross-section diagram of a system 700 that includes a display and optical subsystem, according to one or more embodiments. The system 700 may be incorporated in a head-mountable device, such as the HMD devices 100 or 200, for example. However, it is to be appreciated that the system 700 may be incorporated in other types of devices including, without limitation, cameras, binoculars, office equipment, scientific instruments, etc. Many of the components or features of the system 700 may be similar or identical to components of other systems described herein. Accordingly, the description of such other systems may also apply to the system 700. Further, one or more features or components of the system 700 may be combined with one or more features or components of other systems described herein, and vice versa, such that any combination of the systems of the present disclosure may be used to implement the techniques described herein.

The system 700 may include a display system 702 and an optical subsystem 706. A schematic representation of an eye 708 of a user is also illustrated. Such elements are aligned along an optical axis 710. The display system 702 may include a pixelated display 704 and a circular polarizer 705 positioned in front of the pixelated display to provide circularly polarized light (right-handed in the non-limiting illustrative example). The display system 702 may include a backlight assembly, which emits light, may include a light source, such as one or more light emitting diodes (LEDs), one or more OLEDs, one or more cold cathode fluorescent lamps (CCFLs), one or more lasers, one or more quantum dots, or any combination of these example light sources. The light source in the backlight assembly may emit light across a broad spectrum (e.g., white light) so that the display system 702 can produce color images across the visible spectrum. The backlight assembly may emit light uniformly across its entire front face over a range of about 160 to 180 degrees, for example.

The display system 702, in coordination with the backlight assembly, may emit light over a range of angles up to about 180 degrees (light that is just shy of parallel to the face of the backlight assembly). This range of emission angles is sometimes referred to as the backlight assembly's field of view or the backlight assembly's cone of light. In some embodiments, the display 704 of the display system 702 may be an LCD matrix that includes one or more polarizing layers, a liquid crystal layer, and a thin film transistor layer. The LCD matrix creates images by obscuring portions of the backlight in a pixelated fashion. An image is displayed when light is emitted from backlight assembly and passes through the display 704 (e.g., an LCD matrix) and through the circular polarizer 705. The backlight assembly and the display may be separated from each other, or these two components may be sandwiched together with little, if any, space between them.

The optical subsystem 706 may include a lens assembly 707 to direct light from the display system 702 toward the user's eye 708. The optical subsystem 706 may have a pancake configuration, for example. In this case, the optical subsystem 706 may include an assembly of optical elements configured to direct light from the display system 702 toward the user's eye 708 using on-axis optical folding based, at least in part, on polarization of the light, as described further below. In some embodiments, the lens assembly 707 of the optical system 706 includes a first lens element 712, a second lens element 714, and a quarter-wave plate 718 positioned between the first and second lens elements. Although shown spaced apart for explanatory purposes, the first and second lens elements 712 and 714 may be affixed to (e.g., adhesively bonded using an optically clear adhesive) the quarter-wave plate 718.

In the illustrated implementation, the first lens element 712 includes a first surface 712a and a second surface 712b opposite the first surface, wherein the first surface 712a faces the user's eye 708 during operation and the second surface 712b faces the display system 702. The second lens element 714 includes a first surface 714a and a second surface 714b opposite the first surface, wherein first surface 714a of the second lens element 714 faces the display system 702 and the second surface 714b of the second lens element 714 faces the user's eye 708. The first surface 714a of the second lens element 714 may include a partially reflective coating, such as a coating that reflects 50 percent of incident light and transmits 50 percent of incident light. The partially reflective coating may be polarization independent or polarization dependent. The quarter-wave plate 718 includes a first surface 718a and a second surface 718b opposite the first surface. The first surface 718a of the quarter-wave plate 718 may be adhesively bonded to the second surface 712b of the first lens element 712, and the second surface 718b of the quarter-wave plate 718 may be adhesively bonded to the second surface 714b of the second lens element 714 to form the lens assembly 707.

The optical subsystem 706 may include various other optical elements. For example, the optical subsystem 706 may include at least one polarizing beam splitter 738, also referred to herein as a reflective polarizer. In this implementation, the reflective polarizer 738 may be coated on the first surface 712a of the first lens element 712, otherwise disposed at least substantially adjacent to the surface 712a. The reflective polarizer 738 may substantially transmit light having a first polarization state and substantially reflects light having a second polarization state orthogonal to the first polarization state. In at least some implementations, the reflective polarizer 738 may represent a beam splitter that only lets linearly polarized light of a first orientation (e.g., horizontal) pass through it, thereby reflecting all other light that is not linearly polarized in the first orientation. The reflective polarizer 738 may be considered a linear polarizer reflector, or a reflective linear polarizer. That is, the reflective polarizer 738 may combine the functionality of a linear polarizer and a beam splitter into a single element in at least some implementations.

FIG. 7 shows a folded optical path of the optical system 706, in accordance with one or more embodiments. One or more surfaces of the first lens element 712 or the second lens element 714 may have various shapes, such as spherically concave (e.g., a portion of a sphere), spherically convex, planar, aspheric, a freeform shape, or some other shape. In some embodiments, the shape of one or more surfaces of the first lens element 712 or the second lens element 714 can be designed to additionally correct for various forms of optical aberration. In at least some implementations, the first surfaces 712a and 714b of the first and second lens elements 712 and 714, respectively, may be convex surfaces, and the second surfaces 712b and 714b of the first and second lens elements 712 and 714, respectively, may be planar surfaces. In some embodiments, one or more of the optical elements within the lens assembly 707 may have one or more coatings or layers, such as anti-reflective coatings and enhance contrast coatings, as discussed above. For example, as discussed above, the first surface 712a of the first lens element 712 may include the reflective polarizer 738, and the first surface 714a of the second lens element 714 may include a partially reflective coating, as discussed above.

As noted above, the display system 702 includes a circular polarizer 705 that converts light emitted from the display 704 into circular polarized light. In one or more embodiments, the circular polarizer 705 is a film on the surface of the display 704. The first surface 714a of the second lens element 714 includes the partial reflector coating (e.g., a 50/50 mirror) that is configured to reflect a portion of light incident on its surface and transmit another portion. The quarter-wave plate 718 is configured to convert circularly polarized light into linearly polarized light and vice versa. The first surface 712a of the first lens element 712 includes an anti-reflective coating, and the reflective polarizer 738 is configured to transmit a desired polarization state while reflecting other polarization states.

In operation, light 740 is directed from the display 704 and the circular polarizer 705 to the partial reflector on the surface 714a of the second lens element 714. The light 740 exiting the circular polarizer 705 is right-handed circularly polarized in this example. A first portion (not shown) of the light 740 is reflected by the partial reflector on the surface 714a of the second lens element 714, and a second portion of the light 740 is transmitted by the partial reflector through the second lens element 714 towards quarter-wave plate 718. In some embodiments, the partial reflector on the surface 714a is configured to reflect 50% of incident light (e.g., light 740). The quarter-wave plate 718 changes the polarization of light 740 from circular to linear (referred to as light 745). Light 745 is incident on the reflective polarizer 738, which reflects light that is polarized in a blocking direction (e.g., vertical or “y-direction”) and transmits light that is polarized in a perpendicular direction to the blocking direction (e.g., horizontal or “x-direction”). At this point, light 745 is linearly polarized in the blocking direction. Thus, the reflective polarizer 738 reflects light 745 and the reflected light is referred to as light 750. Light 750 is incident on the quarter-wave plate 718 after passing through the first lens element 712, which changes the light 750 from being linear polarized to light 755 that is circularly polarized. The partial reflector at the surface 714a of the second lens element 714 reflects a portion of the light 755 (while transmitting another portion), as described above. The reflected portion of light 755 is reflected back toward the quarter-wave plate 718 as light 760, which is also circularly polarized. However, the handedness of the light 760 is opposite that of light 755 and 740 due to the reflection from the partial reflector on the surface 714a. In the illustrated example, the light 740 and 755 is right-handed circularly polarized, whereas the light 760 is left-handed circularly polarized. Thus, the quarter-wave plate 718 changes the polarization of the light 760 from circularly polarized to light 765 that is linearly polarized. However, as the handedness of the light 760 is opposite to that of light 755, the polarization of the light 765 is perpendicular to that of light 755. Accordingly, the light 765 is linearly polarized in a direction (e.g., horizontal or “x-direction”) perpendicular to the blocking direction (e.g., vertical or “y-direction”) and is therefore transmitted by the reflective polarizer 738 as light 765 to the eye 708 of the user.

Although the example describes that the reflective polarizer 738 allows horizontally polarized light to pass through to the user's eye 708, and otherwise reflects all other light that is not horizontally polarized light, it is to be appreciated that the reflective polarizer 738 may allow vertically polarized light to pass through to the user's eye 708, and otherwise reflect all other light that is not vertically polarized.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A head-mounted display system operative to present images to an eye of a user, the head-mounted display system comprising:
a support structure configured to be worn on the head of the user;
a display system supported by the support structure; and
an optical system supported by the support structure, the optical system comprising:
a first lens element comprising a first surface and a second surface opposite the first surface, the first surface of the first lens element facing the user's eye during operation and the second surface of the first lens element facing the display system;
a second lens element comprising a first surface and a second surface opposite the first surface, the first surface of the second lens element facing the display system and the second surface of the second lens element facing the user's eye, the first surface of the second lens element including a partial reflective coating;
a quarter-wave plate comprising a first surface and a second surface opposite the first surface, the first surface of the quarter-wave plate adhesively bonded to the second surface of the first lens element, and the second surface of the quarter-wave plate adhesively bonded to the second surface of the second lens element; and
a reflective polarizer positioned between the first surface of the first lens element and the user's eye during operation, the reflective polarizer substantially transmits light having a first polarization state and substantially reflects light having a second polarization state orthogonal to the first polarization state.

2. The head-mounted display system of claim 1 wherein the first surface of the first lens includes an anti-reflection coating.

3. The head-mounted display system of claim 1 wherein the reflective polarizer comprises a reflective linear polarizer.

4. The head-mounted display system of claim 1 wherein each of the first lens element and the second lens element is a plano-convex lens element.

5. The head-mounted display system of claim 1 wherein the first surface of the first lens element has a different surface profile than the first surface of the second lens element.

6. The head-mounted display system of claim 1 wherein the first lens element is formed from a different material than the second lens element.

7. The head-mounted display system of claim 1 wherein the display system produces circularly polarized light for the images.

8. The head-mounted display system of claim 1 wherein the first surface of the first lens element and the first surface of the second lens element each have aspherical, spherical, or freeform surface profiles.

9. The head-mounted display system of claim 1 wherein the reflective polarizer is adhesively bonded to an optically clear substrate.

10. The head-mounted display system of claim 1 wherein the quarter-wave plate is oriented such that the quarter-wave plate converts incident circularly polarized light to linearly polarized light and convers incident linearly polarized light to circularly polarized light.

11. The head-mounted display system of claim 1 wherein the second surface of the first lens element and the second surface of the second lens element are non-planar surfaces.

12. The head-mounted display system of claim 1, further comprising:
an optically-clear element comprising a first surface that is adhesively bonded to the display system and a second surface opposite the first surface that is adhesively bonded to the first surface of the second lens element.

13. The head-mounted display system of claim 1 wherein the reflective polarizer is positioned on the first surface of the first lens element.

14. A head-mounted display system operative to present images to a user, the head-mounted display system comprising:
a support structure configured to be worn on the head of the user;
first and second display systems supported by the support structure; and
first and second optical systems supported by the support structure, each of the first and second optical systems positioned between a respective one of the first and second display systems, and each of the first and second optical systems comprising:
a first lens element comprising a first surface and a second surface opposite the first surface;
a second lens element comprising a first surface and a second surface opposite the first surface, the first surface of the second lens element including a partial reflective coating, and the second surface of the first lens element is directly or indirectly adhesively bonded to the second surface of the second lens element;
a quarter-wave plate comprising a first surface and a second surface opposite the first surface; and
a reflective polarizer positioned between the first surface of the first lens element and the user's eye during operation, the reflective polarizer substantially transmits light having a first polarization state and substantially reflects light having a second polarization state orthogonal to the first polarization state.

15. The head-mounted display system of claim 14 wherein the second surface of the first lens element is directly adhesively bonded to the second surface of the second surface of the second lens element.

16. The head-mounted display system of claim 14 wherein the first surface of the quarter-wave plate adhesively bonded to the second surface of the first lens element, and the second surface of the quarter-wave plate adhesively bonded to the second surface of the second lens element.

17. The head-mounted display system of claim 14 wherein first surface of the first lens of each of the first and second optical systems includes an anti-reflection coating.

18. The head-mounted display system of claim 14 wherein the reflective polarizer comprises a reflective linear polarizer.

19. The head-mounted display system of claim 14 wherein the reflective polarizer is adhesively bonded to an optically clear substrate, and the quarter-wave plate is adhesively bonded to the reflective polarizer.

20. An optical system configured to present images from a display system to an eye of a user, the optical system comprising:
a first lens element comprising a first surface and a second surface opposite the first surface, the first surface of the first lens element facing the user's eye during operation and the second surface of the first lens element facing the display system, the first surface of the first lens element including an anti-reflective coating;
a second lens element comprising a first surface and a second surface opposite the first surface, the first surface of the second lens element facing the display system and the second surface of the second lens element facing the user's eye, the first surface of the second lens element including a partial reflective coating;
a quarter-wave plate comprising a first surface and a second surface opposite the first surface, the first surface of the quarter-wave plate adhesively bonded to the second surface of the first lens element, and the second surface of the quarter-wave plate adhesively bonded to the second surface of the second lens element; and
a reflective polarizer positioned between the first surface of the first lens element and the user's eye during operation, the reflective polarizer substantially transmits light having a first polarization state and substantially reflects light having a second polarization state orthogonal to the first polarization state.

21. The optical system of claim 20 wherein the first surface of the first lens element and the first surface of the second lens element are convex surfaces, and the second surface of the first lens element and the second surface of the second lens element are planar surfaces.
